(19) United States
(12) Patent Application Publication
(10) Pub. No.: US 2025/0314042 A1
(43) Pub. Date: Oct. 9, 2025

(54) CAB

(71) Applicant: KOMATSU LTD., Tokyo (JP)

(72) Inventors: Shingo WATANABE, Tokyo (JP); Tomoko KIKUMA, Tokyo (JP); Takeshi IKEDA, Tokyo (JP)

(21) Appl. No.: 18/292,595

(22) PCT Filed: Aug. 24, 2022
(86) PCT No.: PCT/JP2022/031891

§ 371 Date: Nov. 5, 2024

(30) Foreign Application Priority Data
Sep. 3, 2021 (JP) 2021-144242

(51) Int. Cl. E02F 9/16; B60H 1/34; B60J 3/02

(52) U.S. Cl. CPC E02F 9/163; B60H 1/34; B60J 3/02; B60Y 2200/412

(57) ABSTRACT

A cab includes a ceiling part including a top window, a roll blind, a first duct and a louver. The roll blind includes a screen disposed on an inside of the top window, and a winding device disposed inside the ceiling part on a rear side of the top window. The winding device is configured to wind up the screen. The first duct is disposed inside the ceiling part. The first duct passes below the winding device. The louver disposed further to a front side than the winding device and in a first air outlet of the first duct.

### CROSS-REFERENCE TO RELATED APPLICATIONS

This application is a U.S. National stage application of International Application No. PCT/JP2022/031891, filed on Aug. 24, 2022. This U.S. National stage application claims priority under 35 U.S.C. § 119(a) to Japanese Patent Application No. 2021-144242, filed in Japan on Sep. 3, 2021, the entire contents of which are hereby incorporated herein by reference.

### BACKGROUND

### Technical Field

The present invention relates to a cab.

### Background Information

An air-conditioning device is provided to a cab of a construction machine such as a hydraulic excavator. A configuration is disclosed in which a duct is disposed inside the ceiling so that the wind from the air-conditioning device hits the head of the crew member in the cab (for example, see Japanese Patent Laid-open No. 2005-239005).

In addition, the front windshield of the cab of the hydraulic excavator may be configured, for example, to allow opening and closing by being operable while looking at the excavation target during excavating work. When the front windshield is open, the front windshield is accommodated below the ceiling.

Since the front windshield that can be opened and closed is provided in this way, when the front window is accommodated below the ceiling, the front window may interfere with the duct when the duct is disposed below the ceiling so that the wind from the air-conditioning device will hit the head of the crew member. A configuration is disclosed in which the duct is disposed inside the ceiling in order to avoid such interference with the front window (see FIG. 5 in Japanese Patent Laid-open No. 2007-76535).

### SUMMARY

Conversely, a top window may be provided in the cab of a hydraulic excavator in order to look upwards and a roll blind for blocking sunlight is disposed on the top window.

However, because the internal space of the ceiling is small, when a roll blind is disposed, interference between the roll blind and the air outlet of the duct may occur and the duct cannot be disposed in the desired position. In this case, a louver for the air outlet of the duct is positioned behind the upper body including the head of the crew member and it is difficult for the wind to hit the upper body.

An object of the present disclosure is to provide a cab in which the wind hits the upper body of the crew member even when a roll blind for blocking sunlight is disposed on the top window.

A cab according to a first embodiment of the present disclosure comprises a ceiling part, a roll blind, a first duct, and a louver. The ceiling part includes a top window. The roll blind includes a screen and a winding device. The screen is disposed on the inside of the top window. The winding device is disposed inside the ceiling part on the rear side of the top window and winds up the screen. The first duct is disposed in the inside and passes below the winding device. The louver is disposed further to the front side than the winding device in the ceiling part and in first air outlets of the first duct.

According to the embodiment of the present disclosure, there can be provided a cab in which the wind hits the upper body of the crew member even when a roll blind for blocking sunlight is disposed on the top window.

### BRIEF DESCRIPTION OF THE DRAWINGS

FIG. 1 is a cross-sectional view of the cab of a construction machine according to an embodiment of the present disclosure.

FIG. 2 is a front view of the cab according to an embodiment of the present disclosure.

FIG. 3 is a perspective view of a front portion of the ceiling part of the cab according to the embodiment of the present disclosure, from inside the cab.

FIG. 4 is a perspective view of the ceiling part and an air-conditioning device of the cab according to the embodiment of the present disclosure, from above.

FIG. 5 is a perspective view of the ceiling part and the air-conditioning device of the cab according to the embodiment of the present disclosure, from below.

FIG. 6 is a back surface view for illustrating the structure of the ducts in the ceiling part of the cab according to an embodiment of the present disclosure.

FIG. 7A is a cross-sectional view along lines A-A′ in FIG. 2 illustrating a front portion of the ceiling part of the cab according to the embodiment of the present disclosure.

FIG. 7B is a cross-sectional view along lines A-A′ in FIG. 2 illustrating a rear portion of the ceiling part of the cab according to the embodiment of the present disclosure.

FIG. 7C is a cross-sectional view along lines B-B′ in FIG. 2 illustrating the front portion of the ceiling part of the cab according to the embodiment of the present disclosure.

FIG. 8A is a perspective view of the cross-section along lines E-E′ in FIG. 2 from below.

FIG. 8B is a perspective view of the cross-section along lines E-E′ in FIG. 2 from above.

FIG. 8C is a partially enlarged view of FIG. 8B.

FIG. 9 is a cross-sectional view perpendicular to the front-back direction of the ceiling part 15.

FIG. 10 is a side cross-sectional view including an air outlet of a defroster duct.

FIG. 11 is an illustration with the top window, the roll blind, and the front-back duct portion extracted from FIG. 7A.

### DETAILED DESCRIPTION OF EMBODIMENT(S)

A cab of a construction machine according to the present disclosure will be explained hereinbelow with reference to the drawings.

### Configuration

### Outline of Cab 1

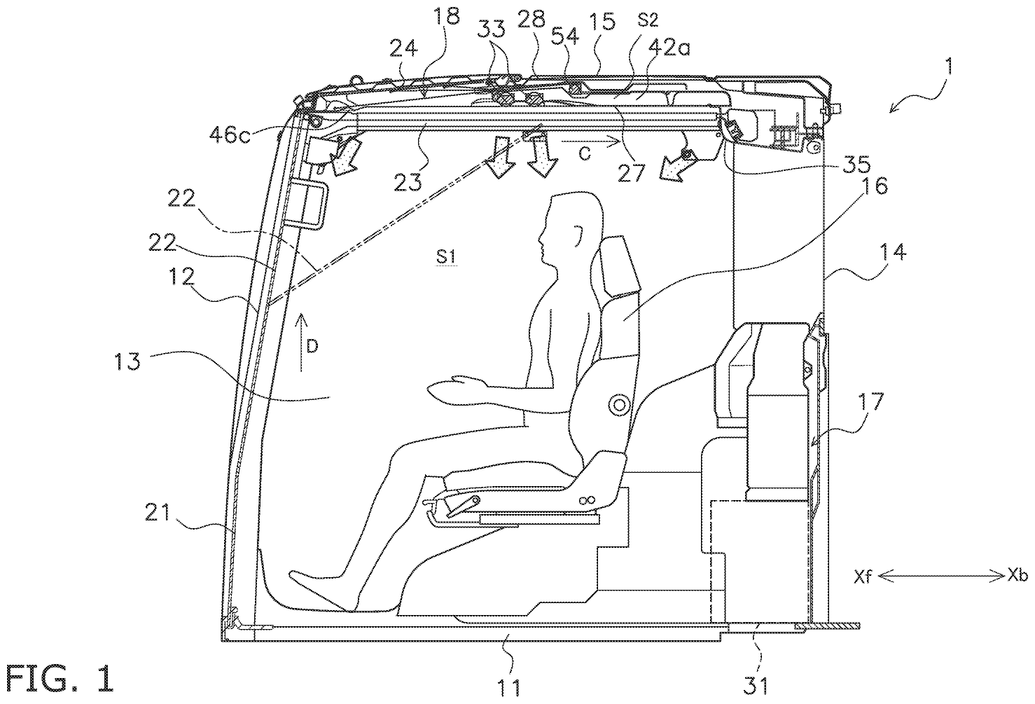

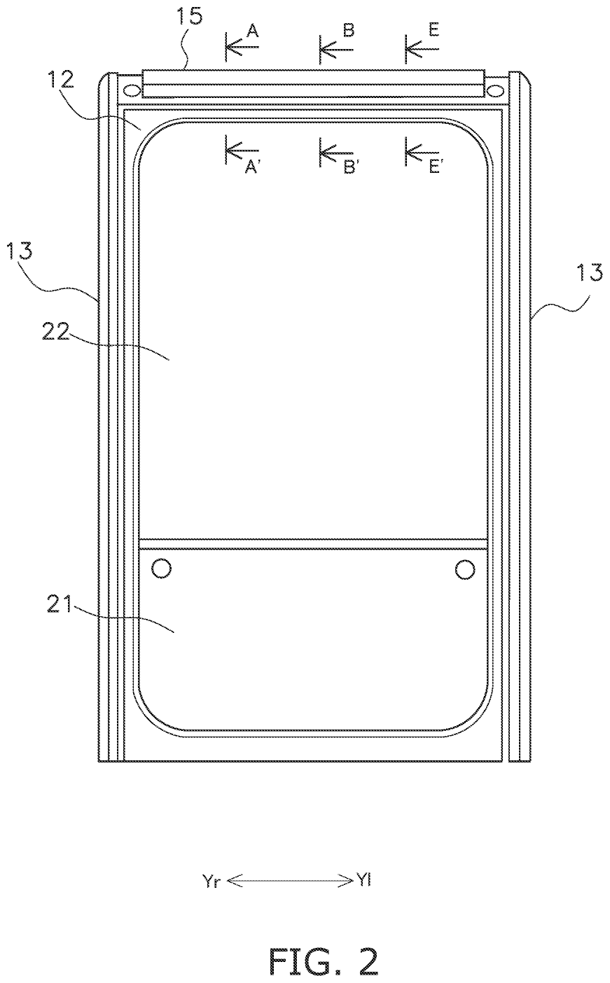

FIG. 1 is a cross-sectional view of a cab 1 of a construction machine of the present embodiment. FIG. 2 is a front view of the cab 1. FIG. 1 corresponds to a cross-sectional view at a position along lines A-A′ in FIG. 2. The arrows in FIG. 1 indicate the wind direction.

The cab 1 is disposed in the construction machine as an operator's seat where the operator sits while driving. A hydraulic excavator is exemplified as the construction machine in which the cab 1 is used.

The cab 1 comprises a bottom surface part 11, a front surface part 12, left and right side surface parts 13, a rear surface part 14, a ceiling part 15, a seat 16, an air-conditioning device 17, and a roll blind 18.

A space S1 surrounded by the bottom surface part 11, the front surface part 12, the left and right side surface parts 13, the rear surface part 14, and the ceiling part 15 forms the operating cabin.

The bottom surface part 11 forms the floor of the operating cabin. The front surface part 12 is disposed upward from the front end of the bottom surface part 11. The upper part of the front surface part 12 is inclined toward the rear. The left and right side surface parts 13 are disposed upward from the end on the left side and the end on the right side of the bottom surface part 11. The rear surface part 14 is disposed upward from the rear end of the bottom surface part 11. The ceiling part 15 is disposed so as to join the upper ends of the front surface part 12, the left and right side surface parts 13, and the rear surface part 14. The ceiling part 15 is curved forward and downward so that the front end is positioned lower than the center in the front-back direction.

The seat 16 is where the crew member sits. The seat 16 is disposed inside the space S1. The air-conditioning device 17 adjusts the temperature of the space S1. The roll blind 18 blocks light or allows light to come through a top window 24 disposed in the ceiling part 15.

Front and rear and left and right of the cab 1 are determined on the basis of the crew member sitting in the seat 16. The arrow Xf indicates the forward direction and the arrow Xb indicates the rearward direction in the drawings. As illustrated in FIG. 2, the arrow Yr indicates rightward and the arrow Yl indicates leftward.

### Front Surface Part 12

The front surface part 12 includes a lower part windshield 21 and an upper part windshield 22. The lower part windshield 21 is disposed in a lower part of the front surface part 12. The upper part windshield 22 is disposed on the upper side of the lower part windshield 21 and in an upper part of the front surface part 12.

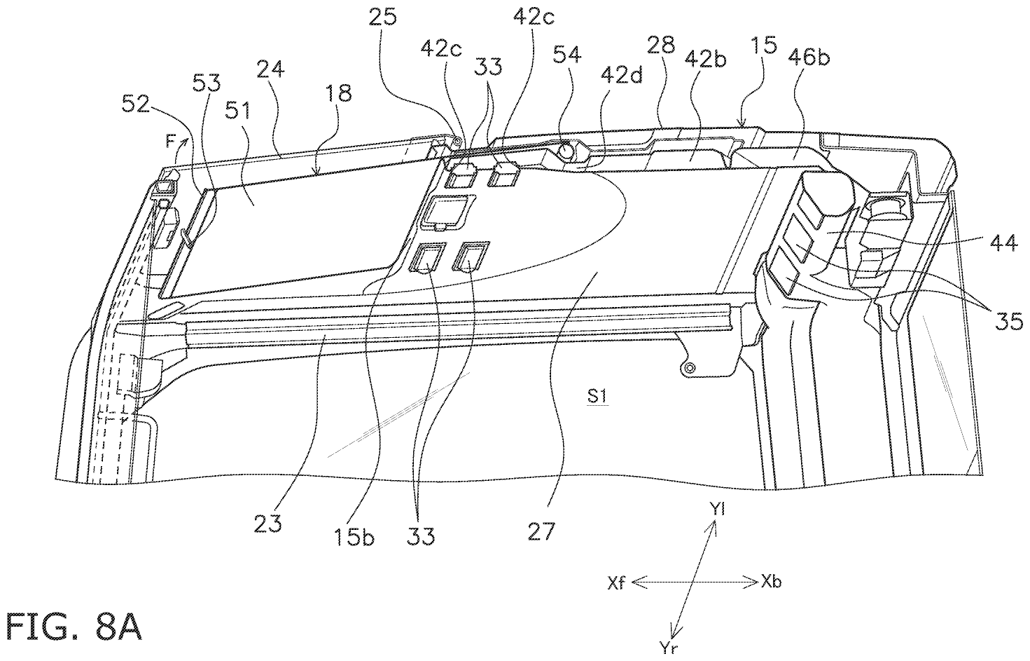

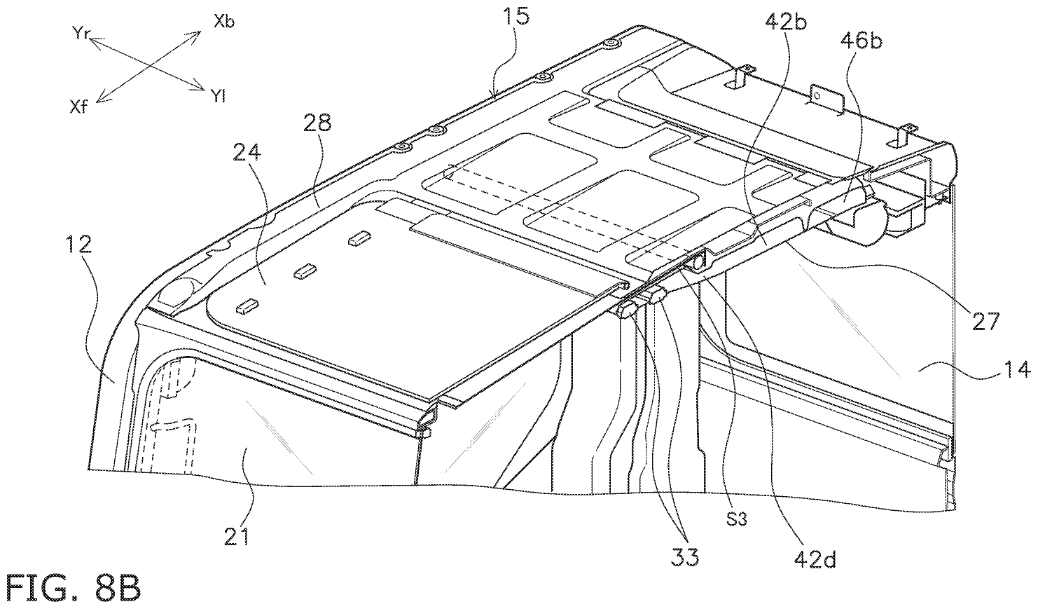

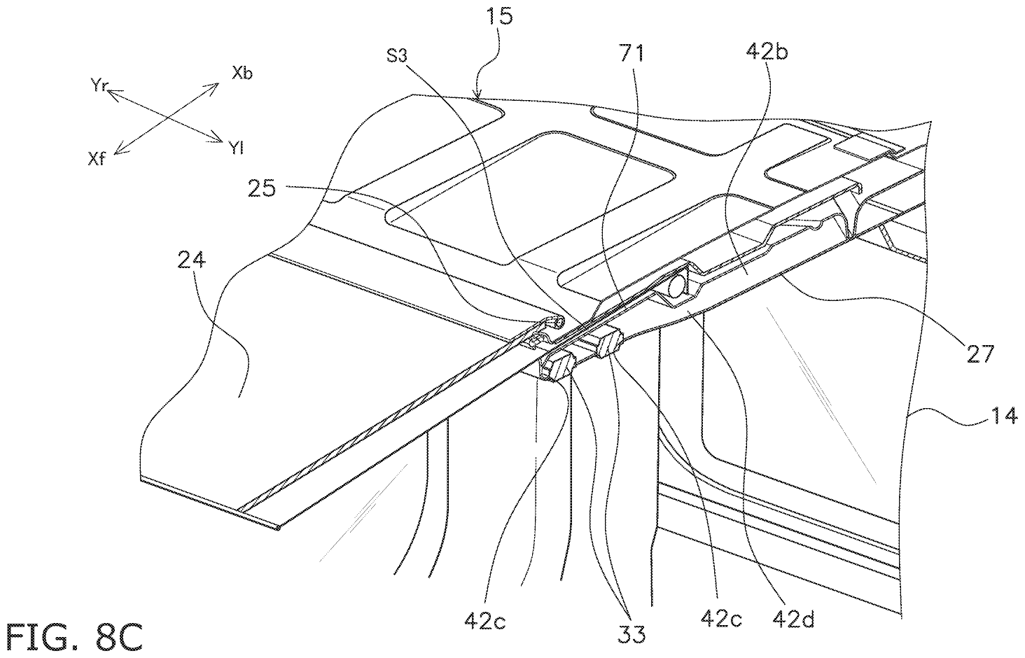

As illustrated in FIG. 1, a guide rail 23 is disposed in the horizontal direction on the inside surface of the left and right side surface parts 13 (refer also to FIG. 8A below). Unillustrated rollers are disposed at the ends in the width direction of the upper part windshield 22. The rollers are guided along the inner surface of the guide rail 23 whereby the upper end side of the upper part windshield 22 slides in the rearward direction Xb as indicated by arrow C, and the bottom end side of the upper part windshield 22 slides upward as indicated by arrow D. The upper part windshield 22 during movement is indicated by the chain double-dashed line in FIG. 1. Consequently, when completely open, the upper part windshield 22 is accommodated below the ceiling part 15 and parallel to the ceiling part 15.

### Ceiling Part 15

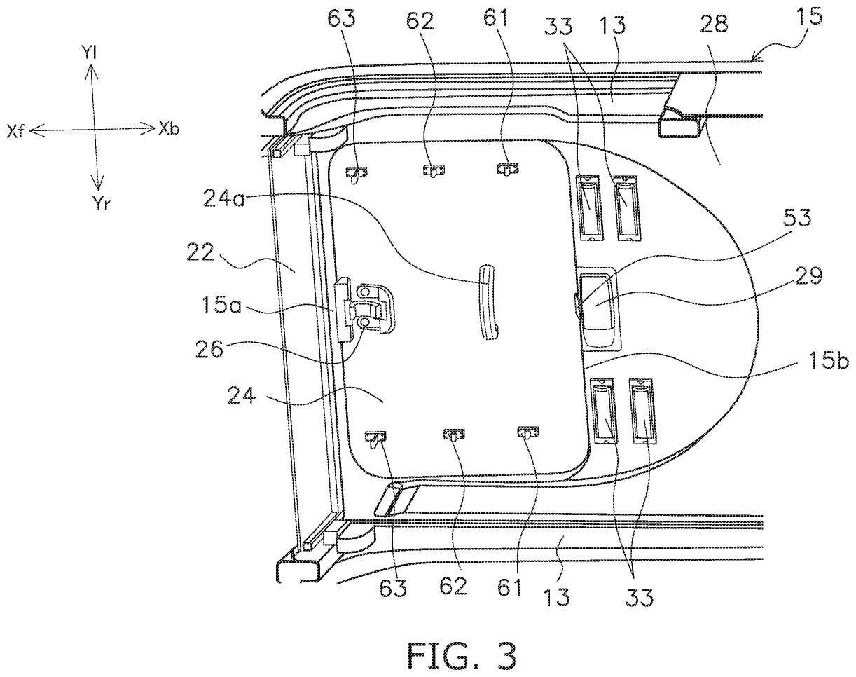

FIG. 3 is a perspective view of a front portion of the ceiling part 15 as seen from inside the cab 1. As illustrated in FIG. 3, the ceiling part 15 includes the top window 24. The top window 24 is disposed in the front portion of the ceiling part 15. The crew member is able to see upward through the top window 24 in a hydraulic excavator, etc.

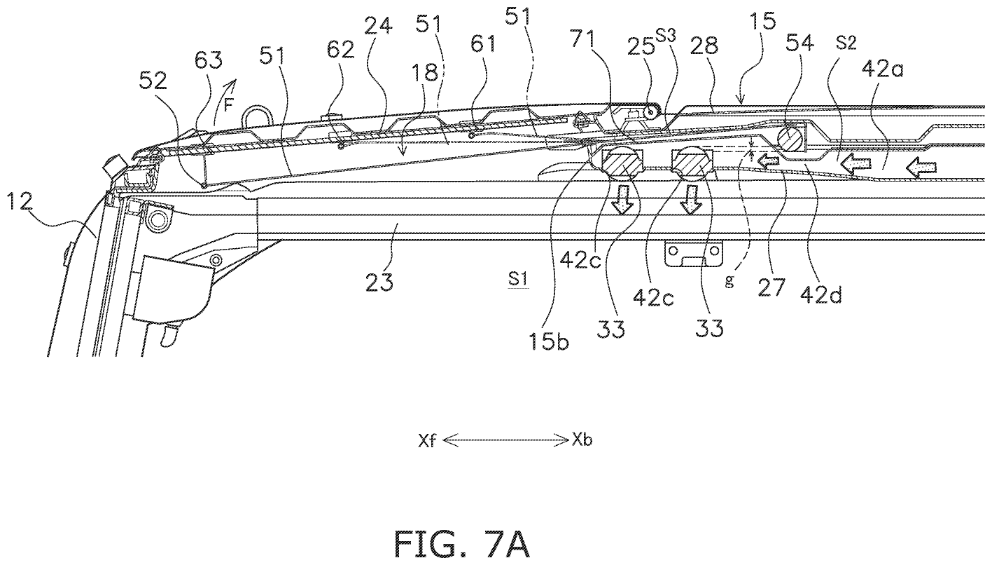

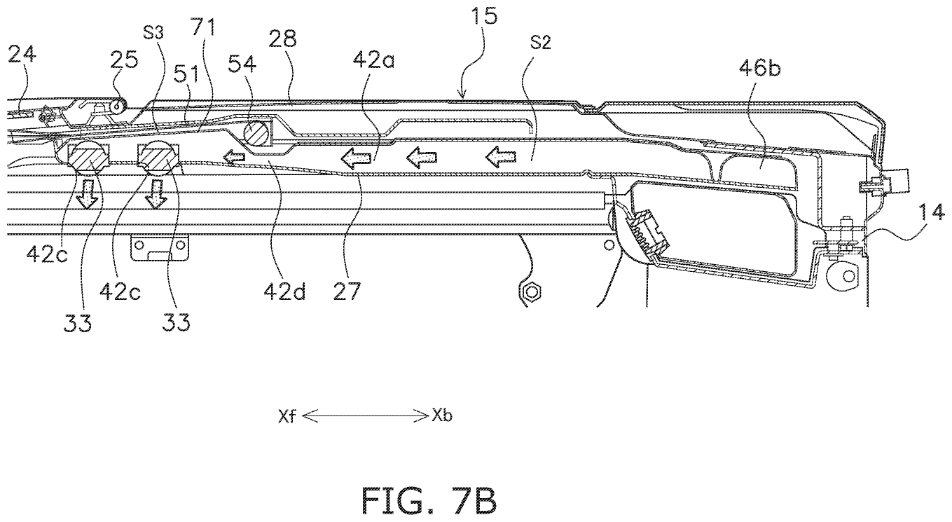

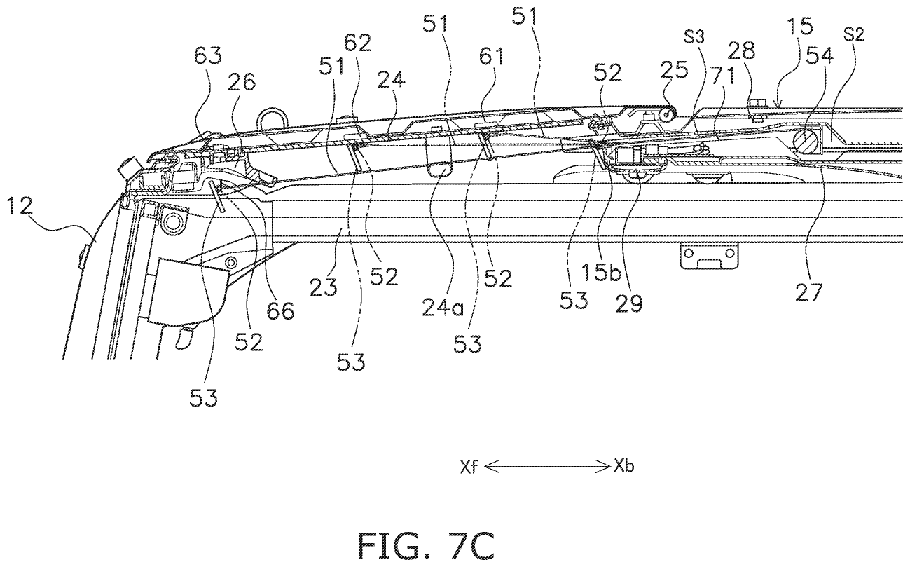

The front end of the top window 24 can be turned upward about the rear end. A hinge 25 (see arrow F in belowmentioned FIG. 7A) is disposed in the rear end of the top window 24 and the front end can be lifted upward centered on the hinge 25. As illustrated in FIG. 3, a lock part 26 is disposed between the front end of the top window 24 and an edge portion 15a of the ceiling part 15 on the front side of the top window 24, and the top window 24 can be locked in a closed state. A handle 24a that is held by the crew member when opening and closing the top window 24 is provided to the bottom surface of the top window 24.

The ceiling part 15 includes, as illustrated in FIG. 1, a decorative panel 27 that faces the space S1 and an outer surface panel 28 that faces outside. Front-back duct portions 42a, 42b (discussed below) of the air-conditioning device 17 and a winding device 54 of the roll blind 18 are disposed in an internal space S2 between the decorative panel 27 and the outer surface panel 28.

As illustrated in FIG. 3, a lamp 29 that illuminates the inside of the cab 1 is provided in approximately the center in the left-right direction on the rear side of the top window 24 of the ceiling part 15. The lamp 29 is provided approximately in the center in the front-back direction as well.

### Air-Conditioning Device 17

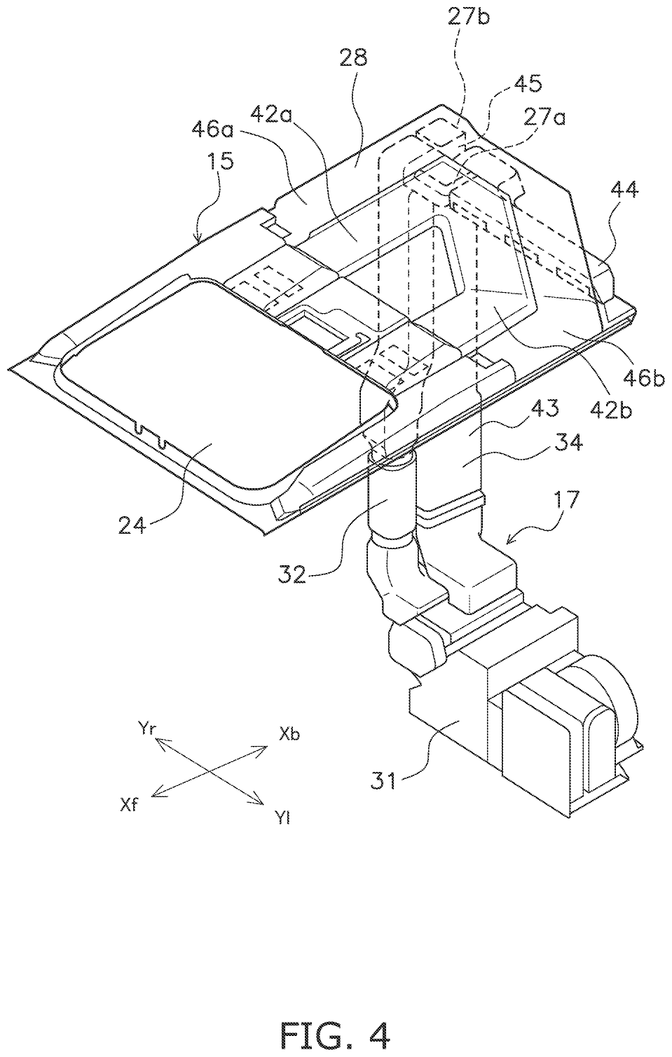

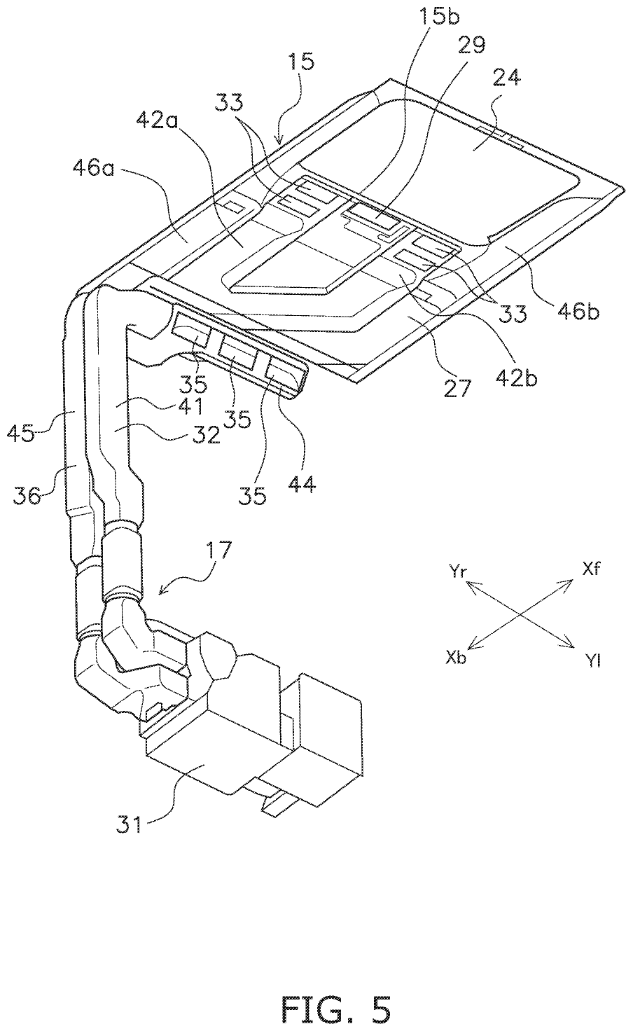

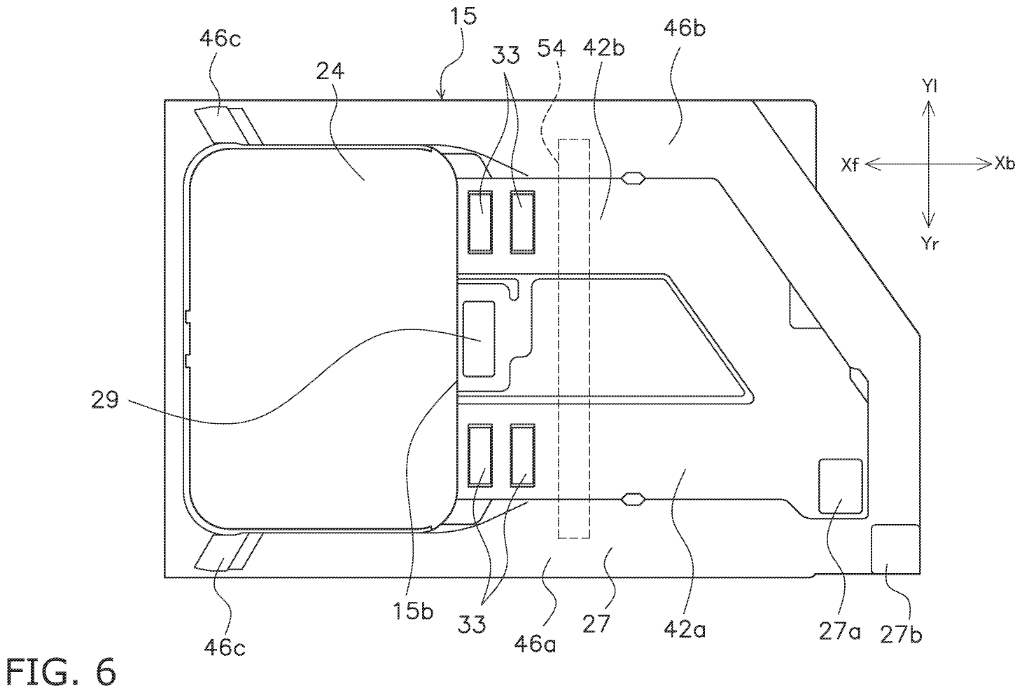

FIG. 4 is a perspective view of the ceiling part 15 and the air-conditioning device 17 as seen from above. FIG. 5 is a perspective view of the ceiling part 15 and the air-conditioning device 17 as seen from below. FIG. 6 is a back surface view for illustrating the structure of the ducts in the ceiling part 15. While the walls that partition the plurality of ducts in the ceiling part 15 are hidden by the decorative panel 27 and the outer surface panel 28 and cannot be seen in FIG. 4-6, the walls are depicted with solid lines for explanation.

The air-conditioning device 17 includes an air-conditioning device body 31, a front duct 32, front louvers 33, a rear duct 34, rear louvers 35, and a defroster duct 36.

The air-conditioning device body 31 is disposed to the rear of the seat 16 as illustrated in FIG. 1. A fan and a heat exchanger, etc., are contained in the air-conditioning device body 31.

The front duct 32 supplies air from the air-conditioning device body 31 to near the center in the front-back direction of the ceiling part 15. The front duct 32 includes a vertical duct portion 41 (see FIG. 5) and the front-back duct portions 42a and 42b (example of a first duct).

The vertical duct portion 41 extends from the air-conditioning device body 31 to the ceiling part 15. The vertical duct portion 41 is disposed in a corner between the side surface part 13 on the right side and the rear surface part 14. The vertical duct portion 41 is joined to an opening 27a (see FIG. 6) in the decorative panel 27 of the ceiling part 15. The opening 27a is formed in the right rear part of the ceiling part 15.

The front-back duct portion 42a and the front-back duct portion 42b illustrated in FIG. 4 are disposed in the internal space S2 of the ceiling part 15. The front-back duct portion 42a and the front-back duct portion 42b are divided in the left-right direction after the opening 27a and extend in the forward direction as illustrated in FIG. 6.

The front-back duct portion 42a extends from the opening 27a in the forward direction Xf up to a rear end portion 15b of the top window 24 as illustrated in FIG. 6. The front-back duct portion 42b extends from the opening 27b, extends left and forward in an oblique direction, and then extends forward up to the rear end portion 15b of the top window 24 as illustrated in FIG. 6.

The front-back duct portion 42a and the front-back duct portion 42b are disposed so as to sandwich the lamp 29 in the left-right direction.

FIG. 7A is a cross-sectional view along lines A-A′ in FIG. 2 illustrating the front portion of the ceiling part 15. FIG. 7B is a cross-sectional view along lines A-A′ in FIG. 2 illustrating the rear portion of the ceiling part 15. FIG. 7A and 7B depict cross-sections of the front-back duct portion 42a. FIG. 7C is a cross-sectional view along lines B-B′ in FIG. 2 illustrating the front portion of the ceiling part 15. FIG. 7C is a cross-sectional view of the front portion of the ceiling part 15 in the center in the left-right direction. FIG. 7A and 7B depict the flow of air in the front-back duct portion 42a with arrows.

The front-back duct portion 42a is joined to two air outlets 42c (example of a first air outlet) formed in the decorative panel 27 and is open to the space S1 of the cab 1 as illustrated in FIG. 7A and 7B. The air outlets 42c are formed in a long and narrow shape in the left-right direction as illustrated in FIG. 6. The two air outlets 42c are disposed side by side in the front-back direction. The front louvers 33 are disposed on each of the two air outlets 42c as illustrated in FIG. 7A.

FIG. 8A is a perspective view of the cross-section along lines E-E′ in FIG. 2 as seen from below. FIG. 8B is a perspective view of the cross-section along lines E-E′ in FIG. 2 as seen from above. FIG. 8C is a partially enlarged view of FIG. 8B.

The front-back duct portion 42b is joined to the two air outlets 42c (example of a first air outlet) formed in the decorative panel 27 and is open to the space S1 of the cab 1 as illustrated in FIG. 6, 8A, and 8B. The air outlets 42c are each formed in a long and narrow shape in the left-right direction. The two air outlets 42c are disposed side by side in the front-back direction. The front louvers 33 are disposed in each of the two air outlets 42c as illustrated in FIG. 8A.

The front louvers 33 are attached to the air outlets 42c so as to be able to rotate about a center axis in the left-right direction. The wind direction can be changed by rotating the front louvers 33.

By disposing the two front louvers 33 side by side in the front-back direction in this way, the crew member is able to freely change the wind as desired by aiming the wind fully on only the head or dispersing and aiming the wind between the head and another portion of the upper body besides the head, or adjusting the wind region by closing a portion thereof.

In addition, because the internal space S2 of the ceiling part 15 is narrow, even though small front louvers 33 are used, it is possible to ensure the wind blowing amount due to disposing two front louvers 33 side by side in the front-back direction.

As illustrated in FIG. 7A and 7B, the front-back duct portion 42a includes a constricting part 42d the thickness of which is reduced in the height direction on the rear side of the front louvers 33. As illustrated in FIG. 8A, the constricting part 42d is also formed on the rear side of the front louvers 33 in the front-back duct portion 42b. The belowmentioned winding device 54 of the roll blind 18 is disposed above the constricting parts 42d.

The rear duct 34 supplies air from the air-conditioning device body 31 to the upper end of the rear surface part 14 as illustrated in FIG. 4. The rear duct 34 includes a vertical duct portion 43 and a left-right duct portion 44.

The vertical duct portion 43 extends along the rear surface part 14 from the air-conditioning device body 31 to the lower side of the ceiling part 15. The vertical duct portion 43 is disposed in a corner between the side surface part 13 on the right side and the rear surface part 14 side by side with the vertical duct portion 41. The left-right duct portion 44 extends leftward from the upper end of the vertical duct portion 43 along the lower side of the ceiling part 15. Air outlets are formed side by side on the left and right in the left-right duct portion 44 and rear louvers 35 are disposed on each of the air outlets as illustrated in FIGS. 5 and 8A.

The defroster duct 36 supplies air from the air-conditioning device body 31 to the front end of the ceiling part 15. The defroster duct 36 includes a vertical duct portion 45 and front-back duct portions 46a and 46b (example of a second duct) as illustrated in FIGS. 4 and 5.

The vertical duct portion 45 extends from the air-conditioning device body 31 to the ceiling part 15. The vertical duct portion 45 is disposed side by side with the vertical duct portions 41 and 43 in the corner between the side surface part 13 on the right side and the rear surface part 14. The vertical duct portion 45 is joined to an opening 27b (see FIG. 6) in the decorative panel 27 of the ceiling part 15 as illustrated in FIG. 4. The opening 27b is formed in the right rear part of the ceiling part 15. The opening 27b is formed further to the outside than the opening 27a.

The front-back duct portion 46a and the front-back duct portion 46b are disposed in the internal space S2 of the ceiling part 15. The front-back duct portion 46a and the front-back duct portion 46b are divided in the left-right direction after the opening 27b and extend in the forward direction as illustrated in FIG. 6.

The front-back duct portion 46a extends from the opening 27b in the forward direction Xf to the front end of the ceiling part 15 as illustrated in FIG. 6. The front-back duct portion 46b extends from the opening 27b left and forward in an oblique direction and then extends in the forward direction Xf up to the front end portion of the ceiling part 15 as illustrated in FIG. 6. The front-back duct portion 46a and the front-back duct portion 46b are disposed outside of the top window 24 in the left-right direction.

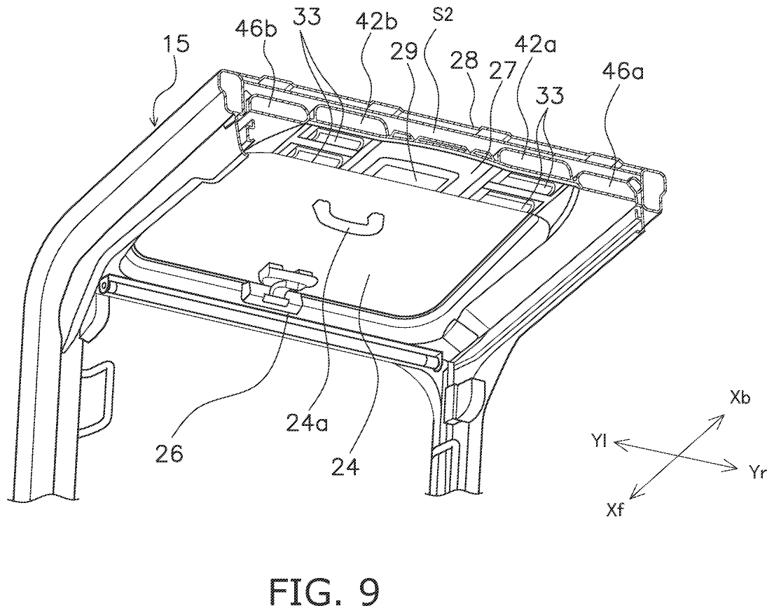

FIG. 9 is a cross-sectional view perpendicular to the front-back direction of the ceiling part 15. Belowmentioned locking members 61, 62, and 63 are omitted in FIG. 9. As illustrated in FIG. 9, the front-back duct portion 46a is disposed further to the right direction Yr-side than the front-back duct portion 42a, and the front-back duct portion 46b is disposed further to the left direction Yl-side than the front-back duct portion 42b. The front-back duct portion 46a and the front-back duct portion 46b are disposed so as to sandwich the front-back duct portions 42a and 42b in the left-right direction.

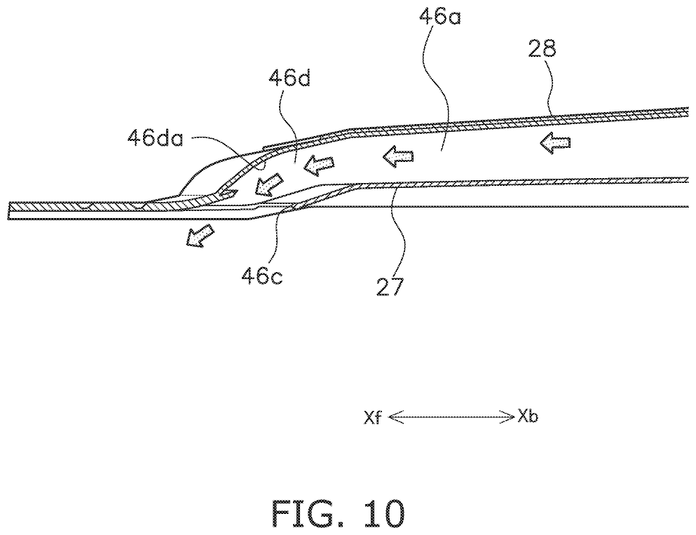

The front-back duct portion 46a is joined to an air outlet 46c formed in the decorative panel 27 and is open to the space S1 of the cab 1 as illustrated in FIG. 6. FIG. 10 is a side cross-sectional view that includes the air outlet 46c. As illustrated in FIG. 10, the front-back duct portion 46a includes a sloped portion 46d that is joined to the air outlet 46c. The sloped portion 46d is sloped forward and downward. Specifically, an upper surface 46da of the sloped portion 46d is sloped so as to progress downward while progressing forward. The upper surface 46da is curved so as to protrude upward.

According to the above configuration, wind can be discharged forward and can hit the upper part windshield 22 regardless of the air outlets 46c being open facing downward.

### Roll Blind 18

The roll blind 18 is provided for covering the top window 24. The roll blind 18 is attached to the ceiling part 15.

The roll blind 18 includes a screen 51, a tip end part 52, a holding part 53, and the winding device 54 as illustrated in FIG. 8A.

The screen 51 is pulled out from the winding device 54. The screen 51 is biased in the winding direction of the winding device 54. The screen 51 is pulled out from the rear end portion 15b of the top window 24 and covers up to the front end of the top window 24. While a black screen 51 may be used for blocking light, the screen 51 is not limited in particular. While the screen 51 may be configured so that the upper side of the screen 51 can be seen through from the crew member, the screen 51 may also be configured so that the crew member cannot see through the screen 51. While the screen 51 preferably has a width that covers the top window 24 in the left-right direction and a length that covers the top window 24 in the front-back direction, a portion of the top window 24 may not be covered.

The tip end part 52 is disposed at the tip end of the screen 51. The tip end part 52 is a rod-like part and is disposed along the left-right direction. The tip end part 52 is locked to locking members 61, 62, and 63 (see FIG. 3) for holding the position of the screen 51 stretched from the winding device 54.

As illustrated in FIG. 3, a pair of locking members 61, a pair of locking members 62, and a pair of locking members 63 are fixed to the top window 24. The pair of locking members 61 are disposed in a rear part of the top window 24. The pair of locking members 61 are disposed side by side in the left-right direction. The pair of locking members 61 are disposed near both ends of the top window 24. The locking member 61 on the left direction Yl-side is disposed near the left end of the top window 24 and the locking member 61 on the right direction Yr-side is disposed near the right end of the top window 24.

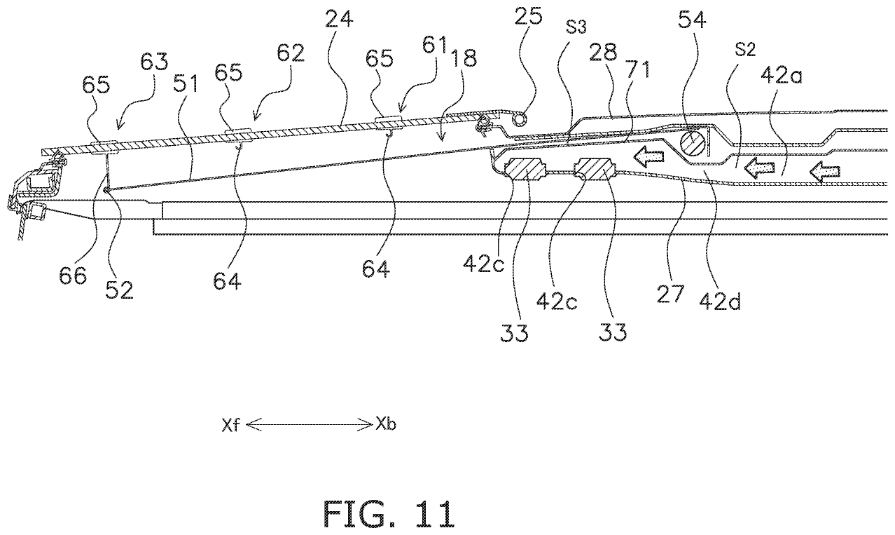

FIG. 11 is an illustration with the top window 24, the roll blind 18, and the front-back duct portion 42a extracted from FIG. 7A. As illustrated in FIG. 11, the locking members 61 each include a hook part 64 and a fixing part 65. The hook part 64 extends downward from the top window 24 and is curved to face forward and is folded back to face upward. The curved portion of the hook part 64 is formed to protrude downward and the tip end part 52 can be disposed therein. The fixing part 65 fixes the hook part 64 to the top window 24. By locking the tip end part 52 to the curved portion of the pair of hook parts 64, the position of the screen 51 can be held.

The pair of locking members 62 are disposed approximately in a center part in the front-back direction of the top window 24. The pair of locking members 62 are disposed side by side in the left-right direction. The pair of locking members 62 are disposed near both ends of the top window 24. The locking member 62 on the left direction Yl-side is disposed near the left end of the top window 24 and the locking member 62 on the right direction Yr-side is disposed near the right end of the top window 24. The locking members 62 are configured in the same way as the locking members 61 and an explanation thereof is omitted.

The pair of locking members 63 are disposed in a front part of the top window 24. The pair of locking members 63 are disposed side by side in the left-right direction. The pair of locking members 63 are disposed near both ends of the top window 24. The locking member 63 on the left direction Yl-side is disposed near the left end of the top window 24 and the locking member 63 on the right direction Yr-side is disposed near the right end of the top window 24. The locking members 63 each include a hook part 66 and the fixing part 65. The hook part 66 extends downward from the top window 24 and is curved to face forward and is folded back to face upward. The curved portion of the hook part 66 is formed to protrude downward and the tip end part 52 can be disposed therein. The fixing part 65 fixes the hook part 66 to the top window 24. The locking members 63 are disposed outside of the lock part 26 in the left-right direction as illustrated in FIG. 3. As a result, the hook part 66 is formed to extend further downward than the lock part 26 so that the screen 51 avoid interfering with the lock part 26 as illustrated in FIG. 7C. By locking the tip end part 52 to the curved portion of the pair of hook parts 64, the position of the screen 51 can be held.

In FIG. 7C, the state in which the tip end part 52 of the roll blind 18 is locked to the locking members 63 is depicted with a solid line, the state in which the tip end part 52 of the roll blind 18 is locked to the locking members 62 is depicted with a chain double-dashed line, and the state in which the tip end part 52 of the roll blind 18 is locked to the locking members 61 is depicted with a chain double-dashed line. The states are depicted in the same way in FIG. 7A. FIG. 8A illustrates the state in which the tip end part 52 is locked with the locking members 63 and the entire top window 24 is covered by the screen 51. While the handle 24a is illustrated in FIG. 7C and overlaps the screen 51, in fact, the pulled out screen 51 would be positioned below the handle 24a.

The holding part 53 is held by the crew member when pulling out the screen 51. As illustrated in FIG. 8A, the holding part 53 is disposed in the middle in the left-right direction of the tip end part 52. The holding part 53 is a substantially plate-like member. The holding part 53 protrudes further downward than the tip end part 52. While the tip end part 52 is not locked to any of the locking members 61, 62, or 63, the screen 51 is wound up by the winding device 54 by the biasing force and the holding part 53 (depicted with a chain double-dashed line) comes into contact with the rear end portion 15b of the top window 24 of the ceiling part 15 as illustrated in FIG. 7C. The position of the cross-section in FIG. 7C is different from that of FIG. 7A, and therefore the holding part 53 is illustrated in FIG. 7C.

As illustrated in FIG. 7C, the top window 24 can be completely covered by locking the tip end part 52 at the locking members 63. The open state of the top window 24 can be changed by locking the tip end part 52 at the locking members 62 or the locking members 61. By removing one's hand from the holding part 53, the screen 51 is automatically wound up by the winding device 54 and the holding part 53 comes into contact with the rear end portion 15b of the top window 24 in the ceiling part 15 as illustrated in FIG. 3 and FIG. 7C.

The winding device 54 has a roll shape, can be rotated about a center axis in the left-right direction, and winds up the screen 51. Additionally, the screen 51 is pulled out from the winding device 54.

The winding device 54 is disposed in the internal space S2 of the ceiling part 15 as illustrated in FIG. 7A. The winding device 54 is disposed along the left-right direction. The winding device 54 is schematically illustrated with a dotted line in FIG. 6.

The winding device 54 is disposed on the rearward direction Xb side of the plurality of front louvers 33 as indicated by the dotted line in FIG. 6. The winding device 54 is disposed from the approximate center of the front-back duct portion 46a to the approximate center of the front-back duct portion 46b while straddling the front-back duct portions 42a and 42b.

As illustrated in FIG. 7A and FIG. 7B, the front-back duct portion 42a that blows air to the front louvers 33 passes below the winding device 54 in the front-back direction. As illustrated by the constricting part 42d in FIG. 7A, the thickness of the front-back duct portion 42a below the winding device 54 is reduced.

As illustrated in FIG. 8A to FIG. 8C, the front-back duct portion 42b that blows air to the front louvers 33 passes below the winding device 54 in the front-back direction. As illustrated by the constricting part 42d in FIG. 8C, the thickness of the front-back duct portion 42b below the winding device 54 is reduced.

As illustrated in FIG. 7C, the winding device 54 is disposed on the rearward direction Xb side of the lamp 29.

By disposing the winding device 54 on the rear Xb side of the front louvers 33 in this way, the front louvers 33 can be disposed above the head of the crew member.

Additionally, as illustrated in FIG. 7A, a portion of the winding device 54 overlaps the front louvers 33 in the vertical direction. That is, a horizontal line from the lower end of the winding device 54 strikes the front louvers 33 and a horizontal line from the upper end of the front louvers 33 strikes the winding device 54. The portion of the front louvers 33 overlaps the portion of the winding device 54 located between the two horizontal lines (see “g” in FIG. 7A) in the height direction (vertical direction). As a result, the thickness of the ceiling part 15 can be suppressed.

As illustrated in FIG. 7A, FIG. 7C, and FIG. 11, a space S3 where the screen 51 is disposed is formed from the winding device 54 to the rear end portion of the top window 24. The space S3 is formed above the front-back duct portions 42a and 42b and the lamp 29 and below the outer surface panel 28. A lower surface 71 of the space S3 is formed sloping forward and downward as illustrated in FIG. 7A and FIG. 7C. As a result, the screen 51 disposed in the space S3 is also disposed sloping forward and downward. In this way, by forming the space S3 for pulling out the screen 51 from the winding device 54 sloping forward and downward, the winding device 54 can be positioned as high as possible in the internal space S2 and a space for forming the ducts below the winding device 54 can be assured.

### Characteristics

(1)

The cab 1 of the present embodiment comprises the ceiling part 15, the roll blind 18, the front-back duct portions 42a and 42b (example of a first duct), and the front louvers 33 (example of a louver). The ceiling part 15 includes the top window 24. The roll blind 18 includes the screen 51 and the winding device 54. The screen 51 is disposed on the inside of the top window 24. The winding device 54 is disposed in the internal space S2 (example of inside a ceiling part) of the ceiling part 15 on the rear side of the top window 24 and winds up the screen 51. The front-back duct portions 42a and 42b are disposed in the internal space S2 and pass below the winding device 54. The front louvers 33 are disposed further to the front than the winding device 54 of the ceiling part 15 and in air outlets 42c (example of a first air outlet) of the front-back duct portions 42a and 42b.

Because the positions of the front louvers 33 can be positioned above the head of the crew member by disposing the front louvers 33 that blow out air further to the front of the winding device 54 in this way, the wind is able to hit the upper half of the body including the head.
(2)

In the cab 1 of the present embodiment, the lower surface 71 of the space S3 in which the screen 51 is disposed from the winding device 54 to the rear side of the top window 24, is sloped downward in the forward direction Xf.

The ceiling part 15 of the cab 1 is formed in a curved manner such that the front end is lower than the center in the front-back direction, and because the winding device 54 can be disposed in the upper part of the internal space S2 in the ceiling part 15 by forming the space S3 in which the screen 51 is disposed so as to slope forward and downward accompanying the curve, a space for disposing the front-back duct portions 42a and 42b can be easily assured below the winding device 54.
(3)

In the cab 1 of the present embodiment, the front-back duct portions 42a and 42b are disposed from the rear toward the front up to the rear side of the top window 24.

As a result, because the position of the front louvers 33 can be disposed near the rear side of the top window 24, the louvers can be easily disposed above the head of the crew member and the wind can easily hit the upper half of the body.
(4)

In the cab 1 of the present embodiment, the front louvers 33 are disposed so as to overlap the winding device 54 in the height direction.

As a result, because the thickness of the ceiling part 15 can be reduced, the height of the cab 1 can be suppressed from becoming too high, and a space up the ceiling part 15 above the head of the crew member can be assured.
(5)

The cab 1 of the present embodiment is further provided with the locking members 61, 62, and 63. The locking members 61, 62, and 63 are disposed at both ends of the top window 24 and lock the screen 51.

As a result, the screen 51 can be easily held inside the top window 24.
(6)

The cab 1 of the present embodiment is further provided with the front-back duct portions 46a and 46b (example of a second duct). The front-back duct portions 46a and 46b are disposed in the ceiling part 15 and pass from the rear toward the front at the sides of the top window 24. The front-back duct portions 46a and 46b include air outlets 46c (example of a second air outlet) and sloped portions 46d. The air outlets 46c are disposed at the front end of the ceiling part 15. The sloping portions 46d are joined to the air outlets 46c and the upper surfaces 46da thereof slope downward in the forward direction Xf.

By providing the sloping portions 46d in this way, the wind is able to hit the upper part windshield 22 without aiming the air outlets 46c forward. Because there is no need to aim the air outlets 46c forward, the thickness of the ceiling part 15 can be reduced.

### Other Embodiments

Although an embodiment of the present invention has been described so far, the present invention is not limited to the above embodiment and various modifications may be made within the scope of the invention.
(A)

While the lamp 29 is disposed in the center in the left-right direction in the above embodiment, the disposition is not limited to the center. In addition, the positions of the front louvers 33 may be changed as appropriate accompanying the position of the lamp 29.
(B)

While the front louvers 33 in the above embodiment are disposed as two side by side in the front-back direction, the present invention is not limited to two. There may be one or three or more front louvers 33.
(C)

While the cab 1 having a configuration in which the upper part of the front windshield can move is discussed as an example in the present embodiment, the cab may also have a configuration in which the front windshield does not move.
(D)

While the top window 24 is configured to be able to be opened and closed in the above embodiment, the present invention may also have a configuration in which the top window 24 cannot be opened and closed.
(E)

While the cab 1 has been explained as disposed on a hydraulic excavator as an example of a construction machine in the above embodiment, the present invention is not limited to a hydraulic excavator and the cab may be disposed on a crane, silviculture equipment, or the like.

A cab of the present disclosure has an effect in which wind hits the upper body of the crew member even when a roll blind for blocking sunlight is disposed on the top window, and is applicable to construction machines, etc.

1. A cab comprising:
a ceiling part including a top window;
a roll blind including
a screen disposed on an inside of the top window, and
a winding device disposed inside the ceiling part on a rear side of the top window, the winding device being configured to wind up the screen;
a first duct disposed inside the ceiling part, the first duct passing below the winding device; and
a louver disposed
further to a front side than the winding device and
in a first air outlet of the first duct.

2. The cab according to claim 1, wherein
a lower surface of a space in which the screen is disposed from the winding device to the rear side of the top window, is sloped forward and downward.

3. The cab according to claim 1, wherein
the first duct is disposed extending from a rear toward a front up to the rear side of the top window.

4. The cab according to claim 1, wherein
the louver is disposed so as to overlap the winding device in a height direction.

5. The cab according to claim 1, further comprising:
locking members disposed at both ends of the top window, the locking members being configured to lock the screen.

6. The cab according to claim 1, further comprising:
a second duct disposed in the ceiling part, the second duct passing from a rear toward a front at a side of top window, the second duct including
a second air outlet disposed at a front end of the ceiling part, and
a sloping portion joined to the second air outlet, an upper surface side of the sloping portion being sloped forward and downward.
